(19) United States
(12) Patent Application Publication
(10) Pub. No.: US 2015/0123540 A1
(43) Pub. Date: May 7, 2015

(54) DEVICE FOR PROVIDING A FLOW OF PLASMA

(71) Applicant: Thomas Bickford Holbeche, Hampshire (GB)

(72) Inventor: Thomas Bickford Holbeche, Hampshire (GB)

(21) Appl. No.: 14/399,278

(22) PCT Filed: May 9, 2013
(86) PCT No.: PCT/GB2013/000206

§ 371 Date: Nov. 6, 2014

(30) Foreign Application Priority Data
May 9, 2012 (GB) 1208298.8

(51) Int. Cl. H05H 1/48

(52) U.S. Cl. CPC H05H 1/48; H05H 2242/10
USPC 315/111.21; 313/46

(57) ABSTRACT

A device for providing a flow of non-thermal gaseous plasma for treatment of a treatment region comprises a cell for the generation of the non-thermal plasma, the cell having an inlet for gas and an outlet for the non-thermal gaseous plasma. The cell is in heat conducting relationship with a heat sink through a heat pipe, the heat sink and the heat pipe both forming parts of the device. The cell typically has a dielectric member of high thermal conductivity in heat conducting relationship with the heat pipe. The heat sink is typically a capsule containing the gas to be supplied to the inlet of the cell.

The present invention relates to a device for providing a flow of a non-thermal gaseous plasma.

A non-thermal gaseous plasma, sometimes referred to as a non-equilibrium gaseous plasma, is a partially ionised gas in which the free electrons are not in thermal equilibrium with the ions and other species in the gas. A non-thermal gaseous plasma is formed by subjecting the gas to an electrical discharge. The electrical discharge is typically created by applying a high voltage across two electrodes separated by the gas. Stray electrons caught in the resulting electrical field are accelerated towards the anode. These electrons collide with the gas and ionise further gas atoms or molecules. Under appropriate conditions of electrical field and gas pressure an avalanche effect will be caused. If sufficient ions and electrons are created there is a visible glow discharge. In addition to the ions and electrons, the electron impact on atoms and molecules present in the gas will excite the atoms and gases. Some gases fluoresce as the excited states almost immediately lose their newly gained energy by giving off photons. The visible photons give the gas discharge a characteristic colour according to the composition of the gas. Some gases, however, for example, argon or helium, also tend to generate excited states which do not fluoresce and therefore have a relatively long lifetime. These relatively stable excited species can cause other gases to ionise (sometimes called “Penning ionisation) or to dissociate. Into free radicals, which are chemically active.

The reactive nature of the electrons, ions and other stable excited and radical species has the consequence that there are a number of potential and actual uses of non-thermal gaseous plasma in medicine, in oral care and in industry.

As a consequence, much research and development has been devoted to devices for producing a non-thermal plasma at a relatively low temperature (e.g. between 20° C. and 40° C.) and at atmospheric pressure. It is believed that the effectiveness of a non-thermal plasma will, depending on the use to which it is put, increase with its concentration of active species.

According to the present invention there is provided a device for providing a flow of non-thermal gaseous plasma for treatment of a treatment region, the device comprising a cell for the generation of the non-thermal plasma, the cell having an inlet for gas and an outlet for the non-thermal gaseous plasma, wherein the cell is in heat conducting relationship with a heat sink through a heat pipe, the heat sink and the heat pipe both forming parts of the device.

The device according to the invention makes possible rapid conduction of heat away from the cell, thereby allowing the cell to be operated for a period of time under conditions which otherwise would create a temperature in the plasma that would be unacceptable for some uses. Take the example of oral care, in this example, it is undesirable to allow the temperature of the plasma to rise much above 40° C.; otherwise, there is a risk of damage to the user's teeth, quite apart from any discomfort caused.

The device according to the invention makes it possible to maintain the temperature of the non-thermal gaseous plasma at or below 40° C. under conditions which would otherwise give rise to a much higher temperature.

The device according to the invention preferably employs, in use, an electrical discharge through a dielectric material. Thus, the device may include a first dielectric member of a dielectric material having a thermal conductivity of at least 100 W/mK (and typically of at least 200 W/mK), and the heat pipe is in direct or indirect heat conducting relationship with the first dielectric member.

The dielectric material is typically aluminium nitride, but other dielectric materials having a high thermal conductivity may alternatively be used.

The heat pipe is preferably in heat conducting relationship with the cell through a thermoelectric cooling means. The thermoelectric cooling means can be operated to accentuate the temperature difference spanned by the heat pipe.

In a typical example of a device according to the invention, the cell comprises a first electrode associated with the second dielectric member and optionally a second electrode associated with a first dielectric member, wherein the first and second dielectric members are configured so as to prevent in use, contact between gas in the cell and the electrodes. (The second dielectric material is typically of the same material as the first ceramic material and the second electrode may be omitted from the cell.) In this example, the first dielectric member is preferably in thermal contact with a thermoelectric cooling means which, in turn, is in thermal contact with the heat pipe.

The cell may be of any convenient configuration. In one example, the first dielectric member and the second dielectric member may be in the form of concentric tubes. Alternatively the first dielectric member and the second dielectric member may both be plates.

The device may incorporate one or more dedicated heat sink members of a known kind. It is preferred, however, that a gas capsule for supplying gas to the cell also acts as a heat sink. The gas capsule is conveniently housed within the device.

The source of electrical power may be at least one battery.

The device may accordingly incorporate or be adapted to incorporate a battery and electrical circuits for converting the voltage signal from the battery into a signal for generating a non-thermal gaseous plasma.

The device according to the invention is conveniently of a weight, size and configuration enabling it to be held and operated by hand.

In operation, there is a tendency for the heat sink to retain heat and therefore rise in temperature with the result that the heat pipe becomes less effective in conducting heat away from the cell over a period of time. In consequence, the temperature of the plasma may start to rise. The device according to the invention may therefore include a gas flow shut-off valve and means for closing the valve automatically if the non-thermal gaseous plasma exceeds a chosen temperature or after a chosen period of continuous operation.

The invention will now be described by way of example with reference to the accompanying drawings, in which:—

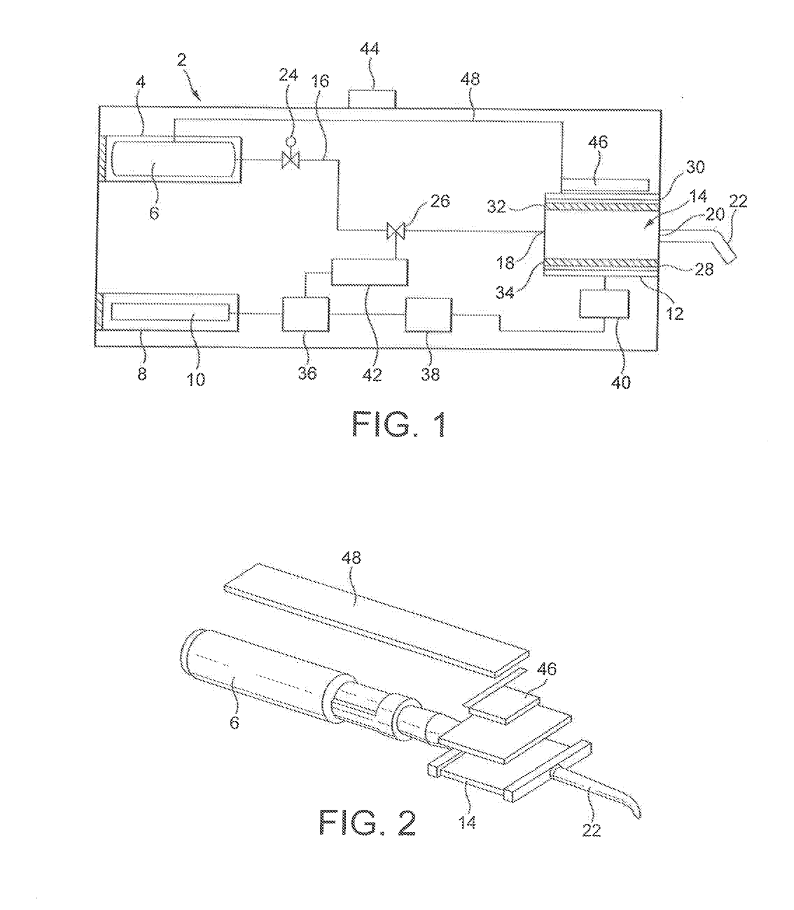

FIG. 1 is a schematic diagram illustrating a treatment device according to the invention;

FIG. 2 is a view in exploded perspective of a sub-assembly of plasma cell, semiconducting the electric device, heat pipe and gas capsule for use in the device shown in FIG. 1;

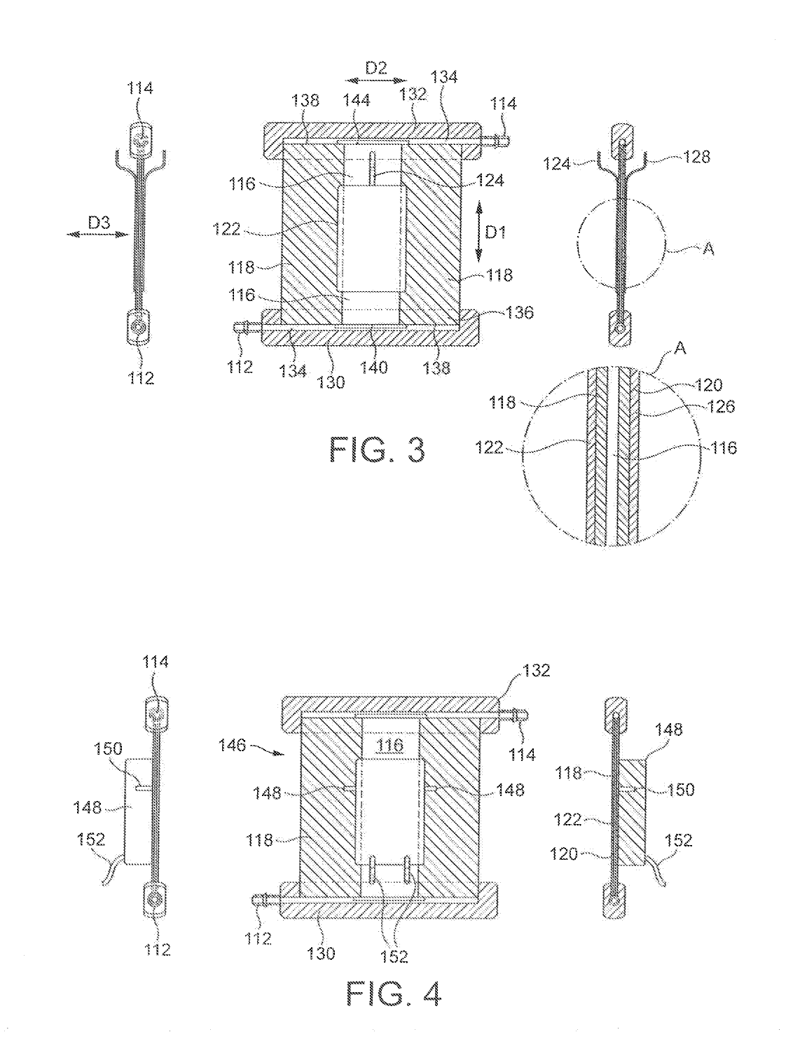

FIG. 3 shows a plasma cell for use in a device according to the invention and includes a plan view, end-on view, cross-sectional view and enlarged cross-sectional view;

FIG. 4 shows another embodiment of plasma cell for use in a device according to the invention and includes a plan view, end-on view and cross-sectional view;

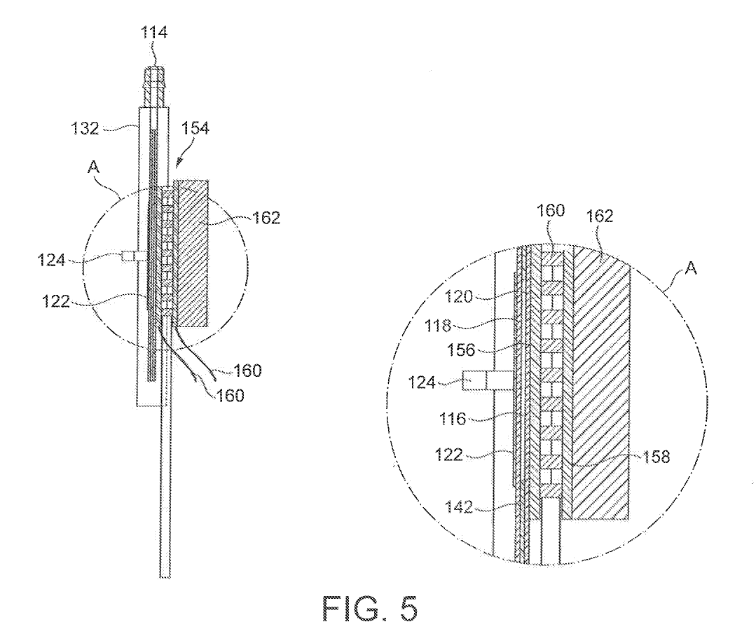

FIG. 5 shows a further embodiment of plasma cell for use in a device according to the invention and includes a cross-sectional view and an enlarged cross-sectional view; and

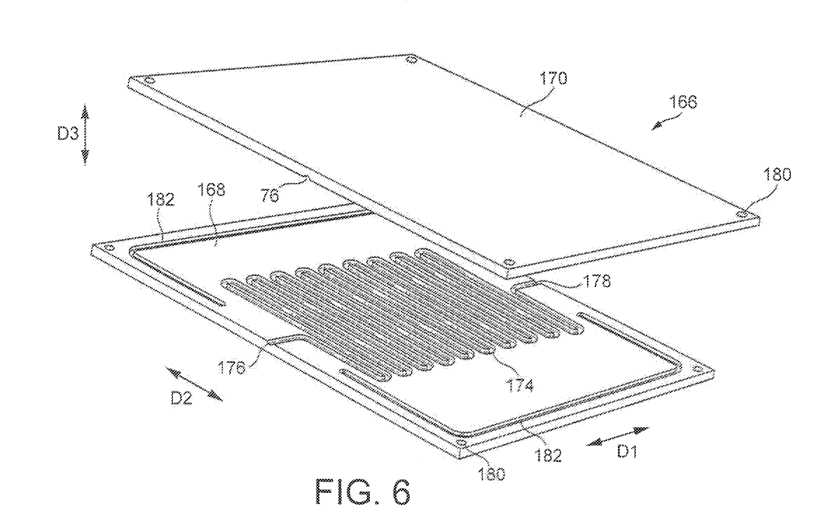

FIG. 6 shows in exploded perspective a yet further embodiment of plasma cell for use in a device according to the invention.

The drawings are not to scale.

Referring to FIG. 1 of the drawings, there is shown schematically a self-contained device 2 for forming a plasma and applying it to a treatment region, for example, the oral cavity of a human being or other mammal. The device is intended to be operated while held in the hand. The device comprises a housing or body 2 of suitable plastics material such as high density polyethylene. The body 2 includes a first assessable compartment 4 for housing a capsule containing a supply of gas under pressure and a second accessible compartment 8 for housing one or more DC batteries 10. The housing 2 also has third compartment 12 in which is located a cell 14 for the generation of a non-thermal gaseous plasma. There is a gas passage 16 in the housing or body 2 which extends from the gas capsule 6 to an inlet 18 to the cell 14. The cell 14 also has an outlet 20 for the discharge of the non-thermal gaseous plasma, the outlet 20 receiving an applicator 22 which is of a shape and size suitable for the treatment that is to be performed using the device shown in FIG. 1. For example, the applicator 22 may be in the form of a tube with an angled outlet for insertion into the oral cavity of a human being. The passage 16 contains a regulator 24 adapted to reduce the pressure of the gas to a value a little above atmospheric pressure and an on-off valve 26. If desired, the regulator 24 may alternatively be incorporated into a shut-off valve (not shown) in the mouth of the gas capsule 6.

As shown in FIG. 1, the cell comprises a first (live) electrode 28 and typically a second (ground) electrode 30. If desired, the second electrode 30 may be omitted from the cell 14, although this is not preferred. It may alternatively be located at the distal end of the applicator 22, or omitted altogether. If the second electrode 30 is provided at the distal end of the applicator 22, generation of the non-thermal plasma may extend out of the cell 14 into the applicator 22.

The first electrode 28 is provided in operation with an AC or DC voltage signal with peaks of a size and frequency able to create and sustain a non-thermal plasma generating discharge, typically a glow discharge, in gas flowing through the cell 14 from the gas capsule 6. The discharge is through a dielectric material that prevents physical contact between the gas and the first electrode 28. In the embodiment shown in FIG. 1, the second electrode 30 is also associated with a dielectric material. Thus, the second electrode 30 is located on an exterior surface of a first dielectric member 32 and the first electrode 28 is located on an exterior surface of a second dielectric member 34. There is therefore no direct contact between the electrodes 28 and 30 and the gas in which the non-thermal plasma is generated. One of the advantages of such a configuration is that arcing is made less likely. Arcing is disadvantageous for a number of reasons including the fact that it is usually accompanied by high temperatures.

In accordance with the invention, the dielectric members 32 and 34 are formed of a material which not only has good dielectric properties but also has a high thermal conductivity. Aluminium nitride is a suitable material having a dielectric strength of 17 kV/mm and a thermal conductivity of about 285 W/m.K. In view of its high dielectric strength, aluminium nitride will not break down when exposed to electric fields suitable for the generation of non-thermal gaseous plasma. Additionally, in comparison with other dielectrics such as quartz, aluminium nitride can readily be moulded into a chosen shape.

The device according to the present invention makes use of the high thermal conductivity of the dielectric material from which the first and second dielectric members 32 and 34 are formed. The dielectric members 32 and 34, in addition to their dielectric and thermal effects, serve to confine the gaseous non-thermal plasma and typically provide boundaries to the cell 14. Although the dielectric members 32 and 34 can be made of any convenient shape, they preferably take the form of flat plates. The dielectric members 32 and 34 are relatively extensive in length and width but relatively thin in thickness. Such a configuration facilitates exposure of the gas to the electric field and ensures that the maximum distance of any gas from the electrodes is small. Further, it makes possible a large internal area of the plasma cell 14 in comparison to the volume of gas it contains at any one time and is therefore conducive to transporting heat away from the gas. In one example, the width of the plasma cell 14 is about 20 mm and the length is about 50 mm, whereas its height is typically less than 1 mm with each of the dielectric members 32 and 34 being less than 0.5 mm in thickness.

There are a large number of different configurations of electric power source and electrical circuitry that can be used to provide a plasma-generating signal to the cell 14. In general, voltage peaks in the range of 1 kV to 10 kV are needed to generate the gaseous non-thermal plasma. The size and frequency of the peaks, be the signal AC one or a pulsed DC one, determine the number of electrons, ion and excited atoms in the non-thermal gaseous plasma that is formed. The frequency of the voltage peaks may typically be in the range of 20-60 kHz, particularly 30-40 kHz, but could be higher, for example up to 100 kHz.

In the illustrated embodiment, a first electronic circuit 36 converts the voltage signal from the batteries 10, which signal is typically in the range 8-16V, into a pulsed DC signal. The signal is conducted to a transformer driver circuit 38 which operates a transformer 40 effective to step up the voltage to a plasma-generating level. The provision of the signal from the batteries 10 to the electronic circuit 36 may be through a control board 42 which controls all the electronic processes within the device 2. The control board 42 may be associated with an external switch 44 that is manually operable to actuate both the gas flow to the cell 14 and the application of the pulsed DC plasma-generating signal to the first electrode 28. Accordingly, the on-off valve 26 may be a solenoid valve which is controlled from the control board 42.

The generation of the non-thermal gaseous plasma within the cell 14 is typically accompanied by some generation of heat. The amount of heat generated depends on a number of parameters including the choice of gas, the peak voltage and the frequency of the voltage peaks. We have observed that with a peak to peak AC signal in the order of 6.7 kV and a frequency in the order of 35 kHz the amount of heat generated is particularly sensitive to gas composition. Thus, if the gas supplied to the plasma cell is pure helium (99.9999% by volume helium) the temperature generated in a plasma cell is less than 40° C. If more than 20% of pure argon is added to the helium, there can be a dramatic increase in the operating temperature of the plasma cell unless heat is dissipated therefrom. Accordingly difficulties can arise in using argon to form the non-thermal gaseous plasma, particularly if the plasma is used for the treatment of the human body. However, if the treatment is bactericidal, a potential advantage of using argon is that it is, we believe, potentially more efficacious because, we believe, under a given set of operating conditions it is possible to achieve a higher concentration of antibacterial species in an argon plasma than it is in a helium plasma, partly because argon has a lower first ionisation potential than helium, and partly because of beneficial reactions between air and the effluent plasma species of argon.

Devices according to the invention make possible efficient heat dissipation from the plasma cells. Referring again to FIG. 1, the first dielectric member 32 is in thermal contact with a thermoelectric cooling device 46. The thermoelectric cooling device 46 comprises an arrangement of alternating p-type and n-type semiconductor elements sandwiched between metallic elements forming an electrical circuit connected to a source of electrical power, which can be the same source that is used to power the plasma generation, which in the embodiment shown in FIG. 1 is provided by the batteries 10. The thermoelectric element may be attached to the first dielectric member 32 through a thermally conductive sheet or by the use of a suitable grease for improving transfer of heat from the member 32 to the thermoelectric device 46. The thermoelectric device 46 thus has a “cold” end in thermal contact with the dielectric member 32 and a “warm” end more remote from the member 32. In order to facilitate the dissipation of the heat from the warm end of the thermoelectric device 46, one or more heat pipes are used to conduct heat away from the device 46 to a heat sink. Heat pipes typically have a thermal conductivity in the order of 10 times that of normal metal conductors such as copper. They exploit the enthalpy of evaporation of a suitable liquid, typically organic. The organic liquid condenses at the cold end of the heat pipe. The condensed liquid is conducted by capillary action through, for example, a wicking member (not shown) to the warm end of the heat pipe where the liquid is vaporised, thereby extracting heat from the member to be cooled.

Referring again to FIG. 1, one end of a heat pipe 48 is in thermal contact with the warm end of the thermoelectric cooling device 46 and the other end of the heat pipe is in thermal contact with the gas capsule 6 which acts as a heat sink, the capsule typically being formed from steel or an aluminium alloy. The heat pipe 48 is typically a flat planar member, the internal configuration of the device 2 being such that the heat pipe can readily extend from the thermoelectric device 46 to the gas capsule 6. In operation of the device shown in FIG. 1, the combination of the thermoelectric device and the heat pipe 48 are effective to conduct heat from the cell 14 to the gas capsule 6. Such conduction of heat takes place as long as the cell 14 is at a higher temperature than the gas capsule 6. After a period of continuous operation, there is a tendency for the temperature of the cell 14 to equalise with that of the gas capsule 6. In consequence, the device according to the invention is more suited to intermittent than continuous operation. There are, however, some uses of non-gaseous plasma that are likely to require operation of a plasma generating device for only short intermittent periods. One example is a device for home oral or dental care, which may be used for no more than a few minutes, typically at the start and end of the day.

We have observed that helium when released from a pressurised gas capsule tends to extract heat from the capsule with the result that its temperature tends to fall. This capsule cooling effect would tend to lengthen a period of operation in which the temperature of the plasma cell 14 is significantly higher than that of the gas capsule 6.

It is not essential that the gas capsule 6 be used as the heat sink. If desired, a dedicated heat sink can be employed in the device instead of or in addition to the gas capsule 6. For example, a plurality of heat pipes 48 could extend from the thermoelectric device 46, one or more to the gas capsule 6 and one or more to the dedicated heat sink. The heat pipe or heat pipes 48 typically have a flat configuration. Such heat pipes are commercially available, particularly for use in computers.

Referring now to FIG. 2, there is shown one possible arrangement of plasma cell 14, thermoelectric device 46, heat pipe 48 and gas capsule 6.

The device shown in FIG. 1 is of a size and weight that it can readily be held and operated by hand. In order to keep down the weight of the device, the gas capsule desirably has a water capacity of less than 40 ml, typically less than 25 ml. An elevated gas storage pressure is favoured so as to keep up the period of time that the device can be operated on one capsule. The gas storage pressure is typically in the range of 50-300 bar although it may be higher. At a typical treatment gas flow rate of 0.5 litres per minute, a 20 ml water capacity gas capsule filled to a pressure of 200 bar will have an operating life of approximately 7-8 minutes.

Although not shown in FIG. 1, the device shown therein may be fitted with non-return valves at the inlet and outlet ends of the plasma cell 14 and may also be provided with an inlet designed to prevent the back discharge of plasma, for example, by being provided its inlet with a porous gas distributor in the form of an expanded PTFE member.

Various other changes and additions may be made to the device shown in FIG. 1. For example, the device may operate from an external power source, for example mains alternating current, instead of the batteries 10. Similarly, an external gas source may be used, in which case a dedicated heat sink may be employed instead of the gas capsule 6 within the housing or body 2.

The gas capsule 6 may be of a kind with an integral regulator as described and shown in WO 2012/010817A. Alternatively, the gas capsule 6 may simply have a seal at its mouth and be provided with a piercing needle to puncture the seal and allow gas to flow.

Referring to FIG. 3, there is shown a device comprising a plasma cell 110 having a cell inlet 112 for receiving a flow of gas into the plasma cell and an outlet 114 through which non-thermal gaseous plasma generated in the cell can be discharged. The plasma chamber 116 is formed between two plates 118, 120, which can be seen most clearly in the enlarged section A. The plates are made of a thermally-conductive dielectric material. An electrode 122 is located on a surface of a plate 118 remote from the plasma chamber 116. The electrode is connected to a source of electrical energy (see FIG. 5) by an electrical conductor 124. Although it is not essential for the invention a second electrode 126 may located on a surface of a the plate 120 remote from the plasma chamber 116 and connected to the source by a conductor 128.

The plasma is generated generally around ambient atmospheric pressure so that active species are generated for discharge to the treatment region. Pressure not significantly different from atmosphere may be adopted as required.

The plasma chamber 116 has a substantially greater extent in a first dimension D1 extending between the inlet and outlet and a second dimension D2 generally lateral to the first dimension than in a third dimension D3 generally orthogonal to said first and second dimensions. As shown the first dimension extends generally through the chamber, the second dimension extends across the chamber and the third dimension extends in the thickness of the chamber. In this example, the plates 118, 120 are spaced apart by spacers 142 which extend on either side of the plasma chamber and seal laterals sides of the chamber and define the thickness of the chamber.

Respective slot manifolds 130, 132 form the cell inlet 112 and cell outlet 114 and convey gas to a chamber inlet 140 and a non-thermal gaseous plasma from the chamber outlet 144. The manifolds 130, 132 have respective central ducts 134 extending from the cell inlet 112 and the cell outlet 114 and terminating at an opposing end of the manifolds. The manifolds have respective grooves 136 which face towards the plasma chamber and communicate with the central ducts. The grooves receive the plates 118, 120 so that they abut against locating shoulders 138. The chamber inlet 140 is a slot formed between the plates at the inlet manifold 130 and the chamber outlet 144 is a slot formed between the plates at the outlet manifold 132. The central ducts communicate with the chamber inlet and chamber outlet along the extent of the inlet and outlet slots in order to deliver and extract a generally equal amount of gas across the width of the plasma chamber. In use, gas is conveyed from the inlet 112 through duct 134 and into the plasma chamber 116 where it is energised to form a plasma.

Whilst slot manifolds are shown the cell inlet and outlet may be formed in any suitable way to increase the distribution of gas in the plasma chamber.

The electrode 122 is generally planar and extends to a substantial greater extent in the first and second dimensions and to a lesser extent in the third dimension. The electrode is at least co-extensive with the plasma chamber in the second dimension thereby restricting the amount of gas which can pass through the chamber without exposure to the generated electric field. As shown, the extent of the electrode in the second dimension D2 is greater than that of the chamber producing a small overlap with the chamber that helps to ensure that the full lateral extent of the chamber is exposed to the electric field generated by the electrode. (In an alternative embodiment (not shown) the electrode may take the form of a fine mesh, providing many edges distributed evenly across the discharge plane.) The lateral sides of the electrode are spaced from the lateral sides of the plate to reduce cross-over. That is, if the lateral sides of the electrode were close to the lateral sides of the plates, the electric field may curve around the sides of the plates rather than passing through plasma chamber and therefore the present arrangement serves to focus the electrical energy into the plasma chamber.

In this example a second electrode 126 is located on a surface of the second plate 120 and has a similar configuration to that of the first electrode.

The electrode and source of electrical energy are preferably configured so that the electrode operates in use at an RMS voltage of between 2 to 8 kV.

The temperature generated in the plasma cell depends on a number of different parameters. For a given flow rate, gas composition, cell volume and cell configuration, increasing the voltage applied to the cell can increase the concentration of excited or activated species but can also increase the temperature of the gas at the exit from the cell. The first effect is often desirable but the second effect may be undesirable (e.g. in oral treatment where it is generally desirable to keep the exit temperature below about 41 degrees C.). The device is therefore, in accordance with the invention, provided with a heat pipe (not shown in FIG. 3) in thermal communication with a heat sink within the device that is in operation normally at a lower temperature than the plasma cell. The heat pipe can therefore enable higher voltages to be applied to the cell than would otherwise be permissible in a given oral treatment device according to the invention.

The planar plasma chamber of the embodiment described herein with reference to FIG. 3 is relatively extensive in the first dimension and the second dimension and yet thin in the third dimension. This configuration produces three benefits. Firstly, the gas is exposed to the electric field for a relatively long period as it passes through the chamber in the first dimension. Secondly, for each unit length in the first dimension, a relatively large amount of gas is exposed to the electric field because of the relatively large width in the second dimension. Thirdly, the relatively small thickness of chamber ensures that the maximum distance of any gas passing through the chamber is only a short distance from the or each electrode, whilst still allowing reasonable gas flow through the chamber. It should also be noted that the internal surface area of the plasma chamber is large compared to the volume of gas and therefore is conducive to transporting heat away from the gas. In the example shown in FIG. 3, the width of the chamber is about 20 mm and the length is about 50 mm. The height of the chamber is preferably less than 1 mm and more preferably about 0.5 mm.

The dielectric plates 118, 120 are also relatively large in the first and second dimensions but thin in the third dimension. In a dielectric medium, the strength of the electric field is reduced as it passes through the medium and therefore the provision of a thin plate allows the electric field to pass through it without significant reduction in strength. In the example shown, the plates have a width and length of about 50 mm and a thickness of preferably less than 1 mm and more preferably about 0.5 mm.

However, it will be noted that many dielectric media have insufficient strength when exposed to an electric field which is sufficiently high to generate an atmospheric pressure plasma in the chamber. Whilst these dielectrics remain polarised and electrically insulating when exposed to low electric fields, a high electric field will cause the medium to break down and conduct electrical charge. If electrical charge passes directly through the medium to the plasma chamber, arcing downstream through the gas to the person being treated may occur and it may also create undesirable active species. For example, with suitable gases such as argon or helium, the potential required at the electrode may be in the region of 1 to 10 kV, and therefore if the plates have a thickness of 1 mm the dielectric strength of the medium must be greater than the corresponding field strength in the range of 1 to 10 kV/mm. Aluminium Nitride is a suitable material having a dielectric strength of 17 kV/mm and therefore will not break down when exposed to a sufficiently high electric field to generate a plasma. Additionally, AIN compared to other dielectrics such as quartz can be moulded into thin uniform sheets.

The selection of the dielectric material of the plates is further restricted since not only should it have a high dielectric strength but because of the increase in temperature in the plasma chamber during ionisation, it is additionally required to conduct heat away from the gas and plasma in the chamber. The temperature of the gas mixture discharged from the plasma chamber depends on the use to which it is to be put, but is typically less than 60° C., and more preferably less than 40° C. Since the ionisation process may, depending on the particular arrangement, heat the gas mixture to as much as 100° C., the temperature must be reduced. Whilst known arrangements provide cooling of a gas and plasma mixture downstream of the plasma chamber, the present embodiments avoid the requirement of additional downstream cooling devices and instead cool the gas and plasma when the gas is still inside the plasma cell. Accordingly, the plates of the present plasma chamber are made of a material having a very high thermal conductivity for conducting heat away from the gas mixture in the plasma chamber. Typically, materials with a high thermal conductivity above 100 W/m.K are metals or metal alloys (such as copper), whereas dielectric materials have relatively low thermal conductivity. Whilst metals will conduct heat away from the plasma chamber, they are clearly unsuitable as electrical insulators. Similarly, dielectric materials are good electrical insulators but poor thermal conductors. Aluminium nitride is a material with high thermal conductivity of around 285 W/m.K. As indicated above, aluminium nitride also has a high dielectric strength and therefore in the preferred embodiments of the invention the plates of the plasma chamber are made of aluminium nitride.

Since gas cooling takes place in the plasma chamber and a separate cooling device is not required downstream of the plasma chamber, the plasma chamber itself can be located closer to the point of application, or treatment. As the active species generated in the plasma chamber have a limited lifetime, which may be fractions of a second, it is desirable to locate the site of plasma generation close to the treatment region to increase the amount of active species which can be used to achieve beneficial results.

A further embodiment of a plasma cell for use in a device according to the invention is shown in FIG. 4. The plasma cell 146 shown in FIG. 4 is similar to that shown in FIG. 3 and therefore like features are given the same reference numerals and will not be described again in detail.

In FIG. 4, a transformer 148 is shown which forms part of the source of electrical energy. The transformer receives electrical energy by a wire 152 from a low potential battery (not shown) located within the housing of the hand-held device and steps up the potential for driving the discharge with a high electrical potential. In this Figure, only one electrode 122 is used. An electrical conductor 150 suitable for carrying high electrical potential extends between the transformer 48 and the electrode 122. It will be seen that the transformer is located in close proximity and therefore the conductor connection may be short to reduce capacitive losses. The transformer generates heat losses during use and requires cooling. Accordingly, the location of the transformer in thermal and intimate contact with the electrode 122 which in turn is located on thermally conductive plate 18 produces cooling of the transformer. This arrangement is useful as it takes further advantage of the high thermal conductivity of the plates, which may be made of aluminium nitride, to conduct heat away from the transformer, without the need for other cooling components elsewhere in the hand-held device. In a modified arrangement of FIG. 4, the transformer may be located on the plate 120 of the plasma chamber and the electrode may be located on the plate 118. The plate 118 may be operatively associated with a thermoelectric cooling device and a heat pipe in a manner analogous to the device shown in and described with reference to FIG. 1.

Another embodiment of the plasma cell is shown in FIG. 5. The plasma cell shown in FIG. 5 is similar to that shown in FIG. 3 and therefore like features are given the same reference numerals and will not be described again in detail.

In FIG. 5, the plasma cell 154 comprises on a surface of the second plate 120 remote from the plasma chamber 116 a thermoelectric cooling device for transporting heat away from the second plate.

In a preferred arrangement of a thermoelectric device, alternating p-type and n-type semiconductor elements are sandwiched between metallic elements forming an electrical circuit connected to a source of electrical power. The flow of charge carriers in the p-type and n-type elements is induced towards the “hot” metallic elements causing heat to flow from the “cold” metallic element. As shown in FIG. 5, a first metallic element 156 (the “cold” element) is in thermal contact with the surface of the second plate 120 and second metallic elements 158 (the “hot” elements) are connected to the first element by alternating p-type and n-type semiconductor regions 160. The first element may be attached to the dielectric plate through a thermally conductive sheet or by grease for improving transfer of heat from the plate to the device. The second element 158 is connected by wires to a source of electrical energy (not shown) for driving the device by applying a potential between the elements that produces a temperature differential between the first and second elements for transporting heat from away from the plasma chamber. The source of electrical power which drives the electrodes may also drive the thermoelectric cooling device. Conveniently, in this case, the transformer of the power supply shown in FIG. 4 and the thermoelectric device are located proximate one another on the same dielectric plate so that the cooled dielectric plate may also conduct heat away from the transformer. The transformer is itself connected to one or more batteries, which may be located away from the cell.

Such a Peltier device is suitable in the present circumstances because the cold element can be configured to be generally planar and extensive in the first and second dimensions. In this case, it has a large area of contact with the plate 120 of the plasma chamber.

In addition to such a thermoelectric device, the cooling device also comprises a heat pipe 162 providing a path for the conduction of heat from the thermoelectric device to a gas capsule or other heat sink incorporated within the plasma generating device.

The thermoelectric device may be operated throughout use dependent on the temperature of the gas in the plasma cell or may be operated intermittently for short bursts of temperature reduction. A sensor (not shown) may be arranged to sense the temperature of the gas and the thermoelectric device operated in response to temperature signals received from the sensor. Alternatively, the thermoelectric device may commence operation only after a period of time from activation of the plasma cell, thereby conserving energy at start up before the plasma cell becomes too hot.

A further embodiment of the plasma cell is shown in FIG. 6. The plasma chamber 166 comprises a heat conductive dielectric plate 168 and another heat conductive dielectric plate 170. In this embodiment, the plate 168 comprises a tortuous duct 174 for conveying gas from a chamber inlet 176 to a chamber outlet 178 and produces a longer gas residence time in the chamber. The net flow of gas between the net and outlet is in the first dimension D1, but unlike the other embodiments described herein, gas in the duct flows through many sections of the duct which extend generally in the second dimension D2. In this way, the period over which a unit of gas is located in the plasma chamber is extended compared to previous embodiments. This increased residence time not only increases the amount of gas that can be energised to form a plasma but also allows more heat to be conducted away from the gas by the thermally conductive plates.

The duct may be produced by cutting a groove in the surface of only one of the plates whilst the opposing surface of the other plate remains planar. Alternatively, complementary grooves may be formed in each plate. The groove or grooves may be formed for example by laser etching to extend a depth of about 0.2 mm into the plate or plates.

The plates are joined together by fasteners (not shown) in through bores 180 of the plates. The plates may additionally comprise peripheral grooves 182 in which sealing means are located for sealing the chamber.

The other components of the plasma cell are similar to those of the previous embodiments and will not be described again.

1. A device for providing a flow of non-thermal gaseous plasma for treatment of a treatment region, the device comprising a cell for the generation of the non-thermal plasma, the cell having an inlet for gas and an outlet for the non-thermal gaseous plasma, wherein the cell is in heat conducting relationship with a heat sink through a heat pipe, the heat sink and the heat pipe both forming parts of the device.

2. The device according to claim 1, wherein the cell includes a first dielectric member of a dielectric material having a thermal conductivity of at least 100 W/(m.K), and the heat pipe is in direct or indirect heat conducting relationship with the first dielectric member.

3. The device according to claim 2, wherein the dielectric material has a thermal conductivity of at least 200 W/(m.K).

4. The A device according to claim 2, wherein the dielectric material is aluminium nitride.

5. The device according to claim 2, wherein the cell comprises a first electrode associated with a second dielectric member and optionally a second electrode associated with the first dielectric member.

6. The device according to claim 5, wherein the second dielectric member is of the same dielectric material as the first dielectric member.

7. The device according to claim 5, wherein the first and second dielectric members define inner walls of the cell.

8. The device according to claim 1, wherein the heat pipe is in heat conducting relationship with the cell through a thermoelectric cooling means.

9. The device according to claim 2, wherein the first dielectric member is in thermal contact with a thermoelectric cooling means which in turn is in thermal contact with the heat pipe.

10. The device according to claim 5, in which the first dielectric member and second dielectric member are both plates.

11. The device according to claim 1, wherein the heat sink is a gas capsule for supplying gas to the cell.

12. The device according to claim 5 wherein the first electrode is connectable to a source of electrical power through a transformer.

13. The device according to claim 12, wherein the transformer and the source of electrical power are both incorporated within the device.

14. The device according to claim 12 wherein the transformer is in thermal contact with the second dielectric member.

15. The device according to claim 12, wherein the source of electrical power is a battery and the device incorporates electrical circuits for converting the signal from the battery into a signal for generating a non-thermal gaseous plasma.

16. The device according to claim 1, wherein the device is of a weight, size and configuration such that it is able to be held and operated by hand.

17. The device according to claim 1, wherein the device includes a gas flow shut-off valve, and means for closing the valve automatically if the non-thermal gaseous plasma exceeds a chosen temperature or after a chosen period of continuous operation.
